(19) United States
(12) Patent Application Publication
(10) Pub. No.: US 2009/0254903 A1
(43) Pub. Date: Oct. 8, 2009

(54) Open framework to interface business applications and content management in media production and distribution environment

(76) Inventors: Eric Denis Dufosse, Portland, OR (US); Cassiano B. Durand, Portland, OR (US); Northon Rodrigues, Oregon City, OR (US)

Correspondence Address: Thomson Licensing LLC, P.O. Box 5312, Two Independence Way, PRINCETON, NJ, 08543-5312, US

(21) Appl. No.: 12/080,998

(22) Filed: Apr. 8, 2008

(51) Int. Cl. G06F 9/46

(52) U.S. Cl. 718/100

(57) ABSTRACT

An open framework to interface at least one business applications and content management in a media production and distribution environment utilizes a standard messaging protocol and a reliable communication bus. The business application creates a work package in a workflow by sending appropriate messages to a workflow engine. The workflow engine generates a work package template corresponding to the intake work orders at the business application. Devices connected to the communication bus are managed and their respective services are exposed to the workflow engine through the illustrative embodiment of the present principles of managed device interfaces. The work package enables the triggering of a complex sequence of actions via the standard messaging protocol.

### TECHNICAL FIELD

The present principles relate content distribution across a network. More particularly, they relate to a media asset management system for organizing, linking and interfacing content subsystems to enable content management facility wide.

### BACKGROUND ART

In the last 10 years, the majority of the broadcast organizations moved from tape-based to a tapeless transmission. In a second step, the production domain became tape-less with the integration of storage area networks that allow operators to have access in parallel to the same content rather then copying it to their local hard disc.

The emergence of such storage networks and the standardization of compression and file exchange formats have created the need to connect a subsystem from vendor A together with subsystems from vendors B and C to improve efficiency. The addition of one or more archives to transmission systems to overcome the expense of online capacity has given rise to the problem of managing content as files rather than tapes. This problem has created the need for media asset management systems capable of managing the large amounts of content.

Today, there exist many subsystems that provide their own small management activities, creating a need for an organization to link existing subsystems (e.g., Ingest, Archive, Production, Transmission . . . ) and legacy systems to allow the administration of content on a facility-wide basis. Thus, a need exists for a facility framework that provides device interfaces to all subsystems, and which unifies their functionality in terms of the various operations they perform (e.g., move, copy, delete, metadata manipulation, and/or transcode content) and advertises those devices and functionality to a central service collector. This allows for the adoption of standardized exchange formats and compression formats such as MXF, GXF, MPEG2, and DV, for example.

Against this backdrop, improving advertising revenues has proven difficult, because in the current broadcast environment, it is very challenging to dynamically change the overall process according to business rules. Existing workflow systems have limited, if any, interaction with the technical infrastructure and therefore make it difficult to change things at the last minute. A television station will have a great competitive advantage if its sales department can sell advertisements in response to short term or changing events (e.g., weather).

The content distribution business is also undergoing challenges due to the increasing number of distribution channels that require support. These challenges have created a more complex business environment and increased operation costs, even though the overall content consumption has not increased in kind. The challenge for content aggregators and distributors is to do more with limited revenue. It is believed that this can only be achieved with a fundamental shift in operations that leverage automated tasks capability.

Content distribution requires consideration of the following constraints:
Security of the content, since new distribution channels facilitate duplication and distribution of the content;
Rights related to programming—it is important to have a system in place that manages various distribution channels and business rules for advertisements in order to prevent illegal distribution of content; and
Content Aggregation is not occurring during playout anymore. Instead, new distribution channels enable content to be consolidated during the distribution or even at the device level (localized branding).

In the media industry, a number of solutions have been provided to address specific needs and these solutions are being forced to converge toward a global solution of media asset management with different levels of workflow management support:
1) Playout Automation:

There exist providers of real-time control systems for devices to playout video and audio content according a schedule. Several playout automation device manufacturers have extended their capability to address the need to organize movement of content at the ingest (content receipt) and storage phases: Generally speaking, the solutions of such manufacturers are focused on video and audio and are not content agnostic. As used herein, the term “content agnostic” refers to the ability to associate (i.e., relate) other types of materials, such as textual scripts, images, spreadsheets, etc.
2) Document Media Asset Management: Companies previously strong in document management have evolved to managing multimedia content. The solutions provided by such companies do handle content agnostically but are limited to managing essences (i.e., the particular audio/video) version.
3) Video Editing. There exist several companies that currently providing video editing solutions. At least one such company now offers a non linear workflow solution for the media industry but, in it only manages content or Assets not workflow processes (work order or work package). Moreover such a workflow solution only manages elements in static workflows.
4) The IT middleware: There also exist IT middleware providers that offer specialized the business layer applications. Such providers have proposed an infrastructure to manage the transactional layer to handle workflows. These providers offer systems that focus on the business layers, and do not provide a user interface per se and can not control resources with load balancing or quality of services constraints.

### BRIEF SUMMARY OF THE PRESENT PRINCIPLES

Briefly, in accordance with a preferred illustrative embodiment of the present principles, there is provided a method for managing content and assets in a manner focused on operation workflow with:

A Dynamic task based user interface, that enables each user know the description of their task, the resource(s) required to execute their task with a unique way to link content and assets, either manually or automatically;

An advanced Media Asset management structure that gives a sufficient level of abstraction to manage a centralized search in complex media creation environment; and

Content related solution with the capability to manage a logical element group of assets.

According to an illustrative embodiment of the present principles, the media asset management system includes a content manager for storing at least one content file, a workflow manager for managing at least one processing operation on the at least one content file, at least one business application managing at least one intake of work orders, at least one device for performing at least one processing operation according to the at least one work order under the management of the workflow manager, and a communications bus for linking the content manager, the workflow manager, the at least one business application and the at least one device by communication messages there between using an independent protocol.

The media asset management system further includes a central monitoring system for aggregating all events from all systems and subsystems connected to the communications bus.

According to other illustrative embodiment of the present principles, the media asset management system includes a notification system for aggregating events from other services and providing notices to services that have subscribed to specific event types.

The media asset management system can also include at least one managed device interface for abstracting the at least one device to expose the at least one device's capability to the workflow manager.

According to yet a further illustrative embodiment of the present principles, the method for content management in a media production and distribution environment, includes the steps of providing device interfaces to all system and subsystems in the media and distribution environment, providing a communication bus and an independent communication messaging protocol between all services and subsystem services, creating work package templates in a workflow engine corresponding to work orders received by a business application service, and creating workflow triggers accessible by the workflow engine and corresponding to a sequence of actions to be performed by one or more of the subsystems in communication with the workflow engine, the workflow triggers automating workflow corresponding to the created work package template.

The details of one or more illustrative embodiment of the present principles are set forth in the accompanying drawings and the description below. Even if described in one particular manner, it should be clear that illustrative embodiment of the present principles can be configured or embodied in various manners. For example, an illustrative embodiment of the present principles can be performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWING

In the drawings wherein like reference numerals refer to similar elements throughout the views:

FIG. 1 depicts a schematic diagram of a typical deployment of the system for workflow, content, resource and asset management in accordance with an illustrative embodiment of the present principles;

FIG. 2 depicts a block diagram of the workflow metadata driven initiation process according to an illustrative embodiment of the present principles; and

FIG. 3 depicts a level flow diagram of a method for workflow metadata driven initiation process according to an illustrative embodiment of the present principles.

### DETAILED DESCRIPTION

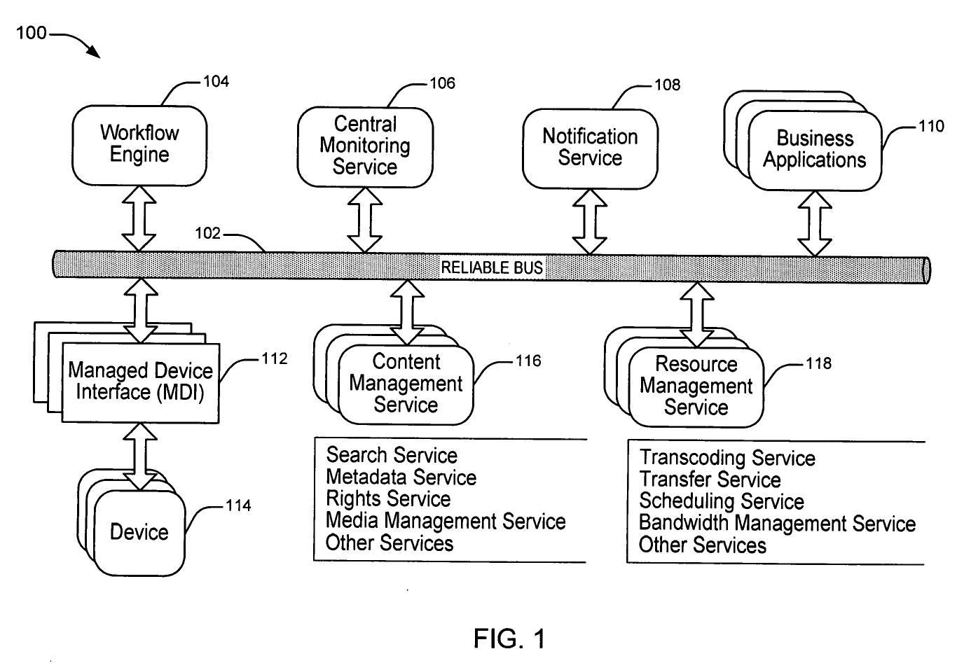

FIG. 1 depicts a block schematic diagram of a content management system 100 in accordance with the present principles. According to this illustrative embodiment, one of the main components is a reliable communication bus 102, which ensures the delivery of messages between services.

According to the present principles, it is fundamental that different elements of the system use a standard based communication protocol, such as, for example, Simple Object Access Protocol (SOAP). This independent communication protocol provides reliable messaging to assure end-to-end message transfer reliability between service endpoints in the system, and uses WS-Reliability to provide a layer of reliability between potentially unreliable or intermittently-connected networks. By using this framework, the system attains an end-to-end reliability regardless of the number of intermediaries between the endpoints. Those of skill in the art will recognize the importance of this aspect of the present invention as it applies to real world systems which have a number of intermediaries between systems, such as HTTP proxies.

The communication bus 102 also provides transactional communications, which ensure that a group of related operations is executed as a single atomic unit. In other words, every operation must succeed or fail. In addition, generally speaking, all systems use SOAP messages for communication, which is standard for communication that is well established in the field of content management.

The communication bus 102 is connected to devices 114 through a Device Interface or Managed Device Interface (MDI) 112. The devices 114 are abstracted as Managed Devices Interfaces, which provide a uniform way to expose the device's capabilities. However, different devices will expose different capabilities depending on the nature of the devices. For example, a storage device, such as a video server, will expose capabilities such as search, transfer, and metadata manipulation, while a transcoder will only expose capabilities to translate between different media formats. The MDI's 112 are developed based on the API provided by the specific device.

Those of skill in the art will recognize that an MDI (or a broker) comprises a device interface which exposes the device to the framework as a service that can perform functions related to the device. The MDI layer will expose the same categories of devices from different manufacturers as generic devices (e.g., video server, transcoder, etc.).

The Workflow Management System 104 is connected to the communication bus 102 and is responsible for the creation of workpackage templates. The Workflow Management System 104 contains the workflow engine that orchestrates the provisioning of other services in performing a sequence of tasks specified in a workpackage. According to one illustrative embodiment of the present principles, the creation of the workpackage includes the creation of watch variables in a metadata field in a database. These variables serve as workflow triggers to automate the workflow.

The central monitoring service 106 aggregates all events from all the systems and subsystems and provides reporting and auditing tools. The central monitoring service 106 provides the capability to collect alarms from technical infrastructure (i.e., from Devices) but also at the operational level (e.g., when a process is aborted, when an operator rejected a task, when a workpackage has been executed). The centralized monitoring service 106 aggregates and differentiates both generic messages and audit messages. This not only allows the monitoring service to trend workflow and media events, but also allows it to create workflow and media access reports, including, for example, top n reports, bottom n reports, access reports and use reports.

The Notification Service 108 leverages the reliable communication bus 102 to aggregate events from the other services and provides notices to services that subscribed to specific event types. An example of a complete transaction would be: 1) advertise a service; 2) register a service; 3) request for a task; 4) connect for a task; and 5) release after completion.

The content management service 116 groups (e.g., combines) the functionality provided by some of the device interfaces (MDIs). For instance, the search service can use the search capabilities of the MDI 112 to obtain certain information. By way of example, the content management service 116 can provide the following services: search; metadata; rights; media management; and other services. The content management service is a generic function that helps to organize and search content.

The present invention provides the capability to manage assets and content according to operation processes. Thus, by facilitating the movement of content on a task based level, an operator is not required to know more than informal instructions (e.g., oral instructions, repetitive task, etc.). This facilitation, in combination with the workflow engine allows operators to manage the content according to operational processes.

A Resource Management Service 118 can be built upon the functionality provided by some device interfaces. For example, a Transfer Service could manage the various transfer channels, providing a priority based queue for performing the transfer. A Resource Management System (not shown) could also provide load balancing for certain functions of the system. Examples of other services provided by the Resource Management service 118 can include transcoding; scheduling; bandwidth management; and other services. The global infrastructure includes a service that can do a job (e.g., a video server that will store and play). For example, upon need of a service from the video server, an application will serve to play a clip from a video server to expose the video in the user interface (UI). Some other services will facilitate the administration of the different functions (load balancing, redundancy, resource mgt. . . . ). To implement a new service, all that is necessary is to implement an interface to the reliable bus according to a generic interface protocol instruction (e.g., SOAP) and the service will advertise its capability and availability to the user.

The Business applications 110 are the clients to the framework of the present principles. They implement the various business processes using the generic interfaces (e.g., SOAP) defined by the various services present in the system.

Interface with Business Application

FIG. 1 depicts in summary form the main interactions between the other components of the system 100 and the business applications or clients 110. Work package templates are designed via a Work Package Template (WPT) Designer which is provided with workflow management system. The work package templates are placed in persistent storage. The work package templates are predefined models of the processes for a specific business scenario. By way of example, each of the work package templates can be compared to a function or method. A work package is an instantiated work package template. In terms of comparison, the work package is a function call for a defined set of input parameters.

The Business Application 110 (client) is responsible for the intake of work orders, which correspond to the services provided by the business. As part of the intake process, each work order is filled and prioritized in accordance to business rules. For each work order, there is a work package template modeling the business processes necessary to fulfill that order. If the service is new, then a new work package template needs to be and will be created.

The business application 110 schedules the work orders based on their priorities. At the appropriate time, the business application creates a work package in the workflow management system 104 by sending the appropriate message. All the parameters necessary to fulfill the corresponding work package template are attributes of the work order, which were filled during the intake process. They are sent to the workflow system together with the name of the work package template to be used. As a result, a new work package is created by the work package creator. At this time, the workflow engine 104 starts evolving the work package in accordance to the flow defined in the work package template.

The invention enables a business application 110 to trigger a complex sequence of actions via a simple command. For instance, an XML notification via SOAP interface with the Workflow engine 104 (e.g., ingest the movie “Tarzan”) can trigger a multitude of tasks (i.e., manual or automatic) according to a workflow defined as Ingest for the movie Tarzan (e.g., record, transcode, transfer, verify, etc.) The infrastructure can also expose back the progress of the progress (work package), completion or failure.

At each stage (e.g., workplace) in the workflow of the work package, actions will occur. Action providers contained in the workflow engine 104 perform these actions. Actions for the content management service system 116 are also controlled by the same mechanism. The framework of the system 100 of the present principles allows the business application 110 to subscribe and receive notices on the status of specific work packages, therefore allowing the business application to provide up-to-date status on the work orders. Finally, the Central Monitoring System 106 monitors the activities of the system providing event monitoring and keeping track of audit trails. This information can be used by the business to improve its processes.

### Open Framework

As described, the framework described herein here provides a fully open platform for the integration of business applications and content management systems in media production and transmission.

It uses a reliable communication bus.

It uses standard SOAP messages between services.

It allows the integration of multiple devices via MDIs.

It allows the transparent integration of services, since the only requirement is that expose a SOAP interface.

It provides a standard way for a service to provide notices to other services (Notification Service)

It provides a central monitoring application.

It provides a workflow engine that can orchestrate the various systems.

The workflow engine 104 manages the logical elements (work packages) which are specific to a media project, and creates, manages and monitors these work packages along with the workflow pattern (template) they have been associated with. The workflow engine makes this framework a power interface to the business application in order to manage media related activities because it can manage processes using technical infrastructure and content according to business or operational processes.

### Definition of the Content Management System via Different Levels of Abstraction:

1) Content management—capability to move or transform content (essences) across devices;

2) Organizing content and its descriptive metadata as Assets (logical elements that can group, link and related different elements together); and

3) Workflow engine allows the management of operational processes (e.g., ingest, archive, restore, play, sell, distribute) by managing content and assets according to the processes.

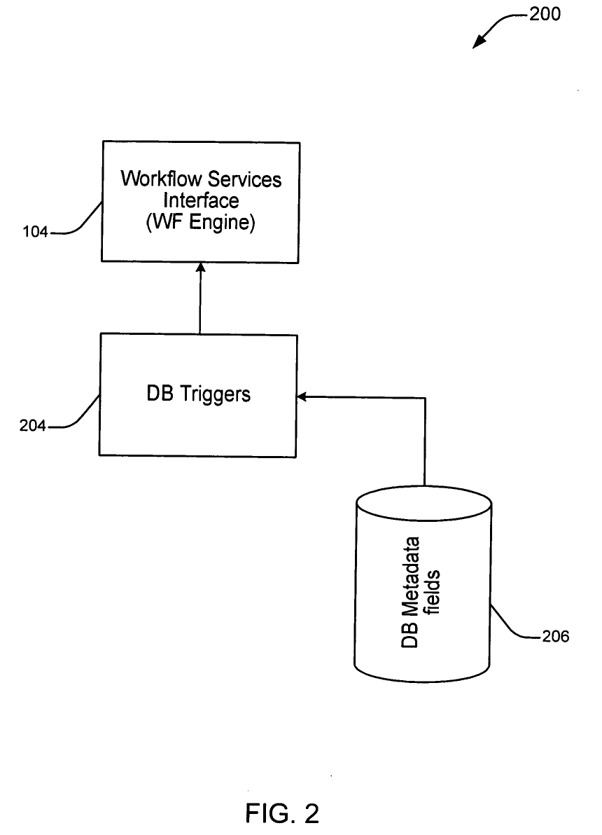

FIG. 2 depicts a triggering process 200 according to an illustrative embodiment of the present principles. The embodiment of FIG. 2 builds on the concepts created by the project workflow definitions discussed above. By creating and using watch variables within a database, workflow can be triggered seamlessly. This enhances workflow automation by creating watch variables in the metadata field in the database 202. Once the database triggers 206 are configured, any modification of its values will initiate a predefined workflow containing values from the metadata field. In this manner, the business application 110 can interface with the workflow engine and create the work packages in the workflow, and execute (i.e., trigger) the corresponding sequence of actions for the work package by issuing a simply (e.g., SOAP) command to the workflow engine. This powerful concept ensures all function access to the database is managed.

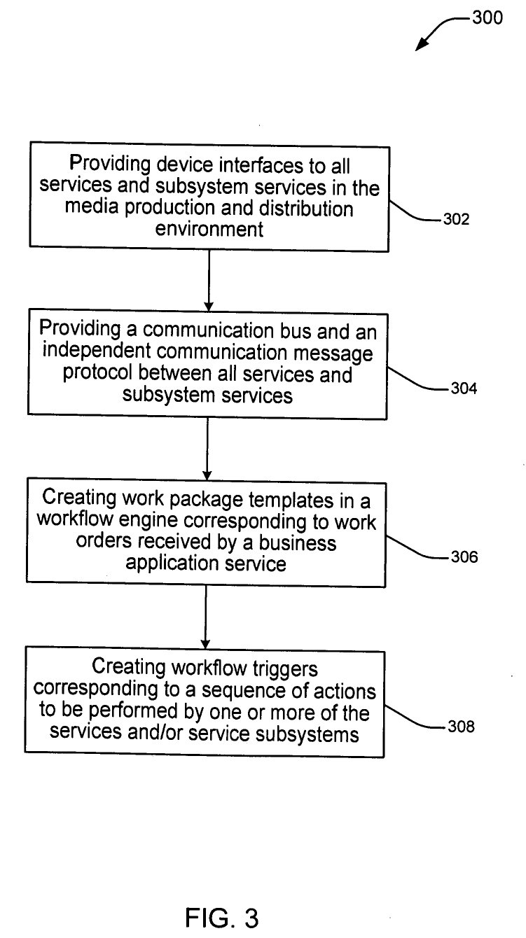

FIG. 3 depicts a flow diagram of a method 300 for the open framework interface to business application and content management in a media production/distribution environment according to an illustrative embodiment of the present principles. Device interfaces are provided to all services and subsystem services in the environment (step 302). This includes, for example, the Content management service 116 (and corresponding subsystem services), the resource management service 118 (and corresponding subsystem services), the MDIs 112, the business applications 110, the central monitoring service 106, the notification service 108 and the Workflow manager (engine) 104.

The communication bus 102 is provided (step 304) between all the services and subsystem services. Work package templates are created (step 306) in the work engine as a result of work orders received by the business application 110, and workflow triggers are created (step 308) corresponding to the sequence of actions to be performed by one or more of the services and/or service subsystems. As mentioned above, these workflow triggers can be based on metadata fields in the databases corresponding to the content and/or the action(s) to be performed.

The illustrative embodiment of the present principles described herein can be implemented in, for example, a method or process, an apparatus, or a software program. Even if only discussed in the context of a single form of illustrative embodiment of the present principles (for example, discussed only as a method), the illustrative embodiment of the present principles of features discussed can also be implemented in other forms (for example, an apparatus or program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device.

Additionally, the methods can be implemented by instructions being performed by a processor, and such instructions can be stored on a processor-readable medium such as, for example, an integrated circuit, a software carrier or other storage device such as, for example, a hard disk, a compact diskette, a random access memory (“RAM”), or a read-only memory (“ROM”). The instructions can form an application program tangibly embodied on a processor-readable medium. As should be clear, a processor can include a processor-readable medium having, for example, instructions for carrying out a process.

As should be evident to one of skill in the art, the illustrative embodiment of the present principles can also produce a signal formatted to carry information that can be, for example, stored or transmitted. The information can include, for example, instructions for performing a method, or data produced by one of the described embodiments. Such a signal can be formatted, for example, as an electromagnetic wave (for example, using a radio frequency portion of spectrum) or as a baseband signal. The formatting can include, for example, encoding a data stream, packetizing the encoded stream, and modulating a carrier with the packetized stream. The information that the signal carries can be, for example, analog or digital information. The signal can be transmitted over a variety of different wired or wireless links, as is known.

A number of illustrative embodiments have been described. Nevertheless, it will be understood that various modifications can be made. For example, elements of different illustrative embodiments can be combined, supplemented, modified, or removed to produce other embodiments. Additionally, one of ordinary skill will understand that other structures and processes can be substituted for those disclosed and the resulting embodiments will perform at least substantially the same function(s), in at least substantially the same way(s), to achieve at least substantially the same result(s) as the illustrative embodiment of the present principles disclosed. Accordingly, these and other embodiments within the scope of the following claims.

1. A media asset management system comprising:
a content manager (116) for storing at least one content file;
a workflow manager (104) for managing at least one processing operation on the at least one content file;
at least one business application (110) managing at least one intake of work orders;
at least one device (114) for performing at least one processing operation according to the at least one work order under the management of the workflow manager; and
a communications bus (102) for linking the content manager, the workflow manager, the at least one business application and the at least one device by communication messages there between using an independent protocol.

2. The media asset management system according to claim 1, further comprising:
a central monitoring (106) system for aggregating all events from all systems and subsystems connected to the communications bus.

3. The media asset management system according to claim 1, further comprising:
a notification system (108) for aggregating events from other services and provides notices to services that have subscribed to specific event types.

4. The media asset management system according to claim 1, further comprising:
at least one managed device interface (112) for abstracting said at least one device to expose said at least one device's capability to the workflow manager.

5. The media asset management system according to claim 4, wherein the content manager is configured to group functionality of at least some of the at least one managed device

6. The media asset management system according to claim 1, wherein the at least one business application in configured to cause the workflow manager to create a work package template corresponding to work orders.

7. The media asset management system according to claim 6, wherein the work package template orchestrates the at least one process operation of the at least one device in performing a predefined sequence of tasks according to the at least one business application.

8. The media asset management system according to claim 1, wherein the independent protocol comprises a Simple Object Access Protocol (SOAP).

9. The media asset management system according to claim 2, wherein the central monitoring system aggregates and differentiates between generic messages and audit messages.

10. The media asset management system according to claim 2, wherein the central monitoring system is configured to trend workflow and media events.

11. The media asset management system according to claim 2, wherein the central monitoring system is configured to create workflow and media access reports.

12. A method for content management in a media production and distribution environment, the method comprising the steps of:
providing (302) device interfaces to all system and subsystems in the media and distribution environment;
providing (304) a communication bus and an independent communication messaging protocol between all services and subsystem services;
creating (306) work package templates in a workflow engine corresponding to work orders received by a business application service; and
creating (308) workflow triggers accessible by the workflow engine and corresponding to a sequence of actions to be performed by one or more of the subsystems in communication with the workflow engine, the workflow triggers automating workflow corresponding to the created work package template.

13. The method according to claim 12, wherein the creating of workflow triggers further comprises creating watch variables in a metadata field in a database.

14. The method according to claim 12, wherein the independent communication messaging protocol comprises a Simple Object Access Protocol (SOAP).
